(19) United States
(12) Patent Application Publication
(10) Pub. No.: US 2006/0179115 A1
(43) Pub. Date: Aug. 10, 2006

(54) Controlling push operation in a communication system

(75) Inventors: Miguel-Angel Garcia-Martin, Helsinki (FI); Thinh Nguyenphu, Southlake, TX (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/123,207

(22) Filed: May 6, 2005

(30) Foreign Application Priority Data
Feb. 9, 2005 (FI) 20050149

(51) Int. Cl. G06F 15/16

(52) U.S. Cl. 709/217

(57) ABSTRACT

A method provides control of push operations in a communication system. The method includes requesting capabilities information associated with a communication device. The capabilities information includes an indication of at least one push method supported by the communication device. The method also receives the capabilities information. The method also decides a way to handle a push operation towards the communication device based on the capabilities information. The capabilities information may be stored as a part of presence information relating to a user of the communication device.

### FIELD OF THE INVENTION

The invention relates to communication systems. More particularly the invention relates to controlling push operation and providing capabilities information in a communication system.

### BACKGROUND OF THE INVENTION

A communication system can be seen as a facility that enables communication sessions between two or more entities such as one or more communication devices and/or other nodes associated with the communication system. A communication system typically operates in accordance with a given standard or specification setting out what the various entities associated with the communication system are permitted to do and how that should be achieved. A standard or specification may define a specific set of rules, such as communication protocols and/or parameters, on which connections between the entities can be based.

Wireless communication systems include various cellular or otherwise mobile communication systems using radio frequencies for sending voice or data between stations, for example between a communication device and a transceiver network element. Examples of wireless communication systems may comprise public land mobile network (PLMN), such as global system for mobile communication (GSM), the general packet radio service (GPRS) and the universal mobile telecommunications system (UMTS). A single communication system may interface with one or more communication systems, such as with other wireless systems, such as a wireless Internet Protocol (IP) network, and/or fixed line communication systems.

Subscribers, such as the users or end-users, to a communication system may be offered and provided numerous services, such as calls, data communication or multimedia services or simply an access to a network, such as the Internet. Servers may be used in provision of the services and may be operated by an operator of a network or by an external service provider. For example, a wireless application protocol (WAP) provides mobile communication devices services over wireless communication networks. Further examples of services may comprises, but are not limited to, short message service (SMS), multimedia messaging service (MMS), electronic mail (email), and so on.

A client of a communication device may request for a service or information from a server, which then responds in transmitting the requested service or information to the client. This may be referred to as a pull operation. An example of a pull operation may comprise a client allowing a user of a communication device to browse the Internet using a WAP or hypertext transfer protocol (HTTP) browser.

in an alternative, a server may transmit information or content without an explicit request from the client. This may be referred to as a push operation. Examples of push operation are discussed more in detail in the following.

A network operator or another party may configure in a communication device or provide the communication device with content or other information relating to the service. Examples of such information may comprise, but are not limited to, information relating to device management (DM). Further non-limiting examples of information may include news, stock quotes, weather, traffic reports and notification of events, such as email or MMS message arrival. The information may be transmitted to the communication device over the air (OTA).

The WAP Forum has defined a push OTA protocol for delivering content over the air from a push server to a communication device, such as a WAP enabled communication device. WAP Push Architectural Overview, Version 03 Jul. 2001, Wireless Application Protocol, WAP-250-PushArchOverview-20010703-a, outlines the WAP push specifications, which together specify a service to push content to mobile devices via the WAP architecture. In a push operation, a push initiator (PI) may transmit push content and delivery instructions to a push proxy gateway (PPG), which may then deliver the push content to a client in the communication device according to the delivery instructions. A push initiator and a push proxy gateway may be separate entities or co-located in a single entity.

The push OTA is an application layer protocol that can be run on top of a wireless session protocol (WSP) for connectionless or connection-oriented push or on top of the HTTP for connection-oriented push. The push OTA protocol may thus be referred to as OTA-WSP and OTA-HTTP, respectively. For initiating connectivity, the PPG may send a request, such as a session initiation request (SIR), to a communication device to initiate connectivity. The request may be sent by connectionless push provided by the OTA-WSP, for example by means of an SMS. The communication device may then activate a bearer for a session as requested in the request and establish a session towards the PPG. The session may be a WSP or HTTP session or a transmission control protocol (TCP) connection.

In a US patent application filed on 17 Feb. 2005, claiming priority from a Finnish patent application 20041634, filed on 20 Dec. 2004 by the Assignee, and having a title “Establishing a push session in a communication system”, a mechanism is described for providing from a push server to a communication device new type of push protocol over a transport protocol information.

The PPG may be able to select one of the push methods to be used for transmitting push information. The PPG then transmits push information to communication devices the server is serving using the selected push operation. However, receiving communication devices typically have different capabilities and do not all support same operations. For example, new devices on the market often support sophisticated push solutions, but at the same time, there are a lot of old devices in use, which support only plain push solutions.

Therefore, it might be desired that the push gateway, such as the PPG, could select on a case-by-case basis, which push mechanism to use in transmitting push information to a communication device or to a group of communication devices. Communication devices may have different capabilities and may support different push operations. A communication device may be unable to support several simultaneous connections to different or heterogeneous networks. An example may comprise, but is not limited to, several simultaneous PDP contexts, with different access points.

Furthermore, it might be desired for an operator of the push gateway to be able to know what kind of push operations communication devices support. This might enable the operator, for example, to use advanced push solutions for communication devices supporting the advanced push solutions, yet being able to serve also communication devices not supporting such advanced push solutions.

### SUMMARY OF THE INVENTION

In accordance with an aspect of the invention, there is provided a method for controlling push operations in a communication system. The method comprises requesting capabilities information associated with a communication device, the capabilities information comprising an indication of at least one push method supported by the communication device. The method further comprises receiving said capabilities information. The method further comprises deciding a way to handle a push operation towards the communication device based on said capabilities information.

In accordance with another aspect of the invention, there is provided a method for transmitting information in a communication system. The method comprises receiving capabilities information associated with a communication device, the capabilities information comprising indication of at least one push method supported by the communication device. The method further comprises storing said capabilities information as a part of presence information. The method further comprises receiving a request for said capabilities information. The method further comprises selecting requested capabilities information from the presence information in response to the request. The method further comprises providing said capabilities information.

In accordance with another aspect of the invention, there is provided a method for publishing capabilities information in a communication system. The method comprises creating a request for publishing capabilities information associated with a communication device, the capabilities information comprising indication of at least one push method supported by the communication device. The method further comprises transmitting the request to a network entity controlling presence information.

In accordance with another aspect of the invention, there is provided a computer program comprising program code means for performing any of the steps of the method according to embodiments of the invention when the program is run on a computing means.

In accordance with another aspect of the invention, there is provided a signaling element for a communication system. The signaling element provides information on at least one push method supported by a communication device.

In accordance with another aspect of the invention, there is provided a push gateway for a communication system. The push gateway is configured to request capabilities information associated with a communication device, the capabilities information comprising indication of at least one push method supported by the communication device. The push gateway is further configured to receive said capabilities information. The push gateway is further configured to decide a way to handle a push operation towards the communication device based on said capabilities information.

In accordance with another aspect of the invention, there is provided a communication device. The communication device is configured to create a request for publishing capabilities information associated with the communication device, the capabilities information comprising indication of at least one push method supported by the communication device. The communication device is further configured to transmit the request to a network entity controlling presence information.

In accordance with another aspect of the invention, there is provided a communication system. The communication system comprises at least one push initiator for submitting push operations towards at least one communication device. The communication system further comprises a push gateway for performing the push operation towards the at least one communication device. The communication system further comprises a presence server for storing and providing capabilities information associated with a communication device, the capabilities information comprising indication of at least one push method supported by the communication device. The push gateway is configured to fetch said capabilities information from the presence server and to decide a way to handle the push operation based on said capabilities information.

### BRIEF DESCRIPTION OF THE DRAWINGS

The invention will now be described in further detail, by way of example only, with reference to the following examples and accompanying drawing, in which:

FIG. 1 shows an example of an arrangement in which the embodiments of the invention may be implemented; and

FIG. 2 shows a signaling chart illustrating an exemplifying embodiment of the invention.

### DETAILED DESCRIPTION OF PREFERRED EMBODIMENTS

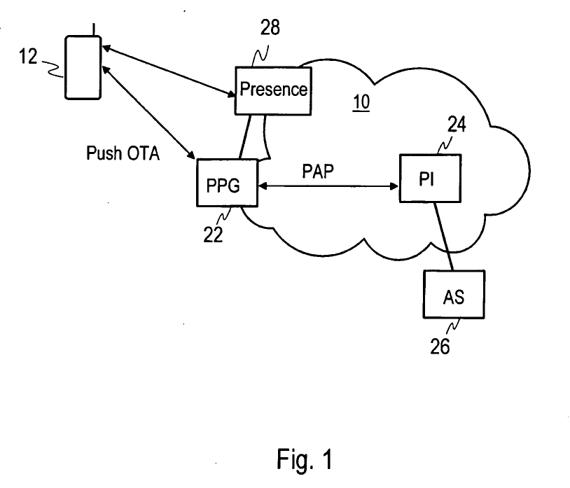

FIG. 1 shows an example of an arrangement including a communication network 10, a communication device 12, a push proxy gateway (PPG) 22 and a push initiator (PI) 24. Furthermore, an application server (AS) 26 and a presence server 28 are shown.

The PPG, or another push gateway or push entity, may implement network access-control policies about who is able to gain access to the network, that is, who is able to push content and who is not, under which circumstances, and so on. The PI 24 and the PPG 22 may communicate between each other using a push access protocol (PAP) as summarized in the document WAP-250-PushArchOverview-20010703-a. The PAP supports push submission, result notification, push cancellation, push replacement, status query and client capabilities query. In push submission, a message comprising a control entity, a content entity and optionally a capability entity is sent from the PI 24 to the PPG 22. The control entity contains the delivery instructions for the PPG 22. The control entity may be an extensible markup language (XML) document.

The PI, or another push server, may be a separate network entity or a single network entity with the push gateway, such as with the PPG. In embodiments of the invention, the push server may be provided in a device management server, in a multimedia messaging service center (MMSC) or in another appropriate network entity.

It shall be appreciated that FIG. 1 is only an example showing only one communication network in connection with one communication device, one push proxy gateway together with one push initiator and one application server. The number and type of entities concerned in a communication system may differ substantially from that which is shown. The communication networks typically further comprise various switching and other control entities and gateways for enabling the communication for interfacing a single communication network with one or more communication networks. In order to enhance clarity, these control entities are not shown in FIG. 1. A communication system is typically arranged to serve a plurality of communication devices. Furthermore, a communication device may have several simultaneous communication connections to different or heterogeneous networks, for example, but not limiting to, a number of session initiation protocol (SIP) sessions and activated packet data protocol (PDP) contexts. Communication devices may be connected to the communication system from the same or different networks. Communication devices may access the communication network 10 via any appropriate access system. Examples may include, but are not limited to, radio access networks, e.g. an UMTS terrestrial radio access network (UTRAN) or a GSM/EDGE radio access network (GERAN), Wireless Local Access Networks (WLAN), Code-Division Multiple Access (CDMA) networks, and short-range wireless systems, such as the Bluetooth, different types of fixed access systems, and so on.

A mobile communication network may logically be divided into a radio access network (RAN) and a core network (CN). The communication device 12 may access the communication network 10 via an access entity (not shown) of the RAN. The communication device 12 may, for example, wirelessly transmit and receive radio signals via a radio interface to and from a transceiver network element connected to the access entity. Correspondingly, the transceiver network element may wirelessly transmit and receive radio signals to and from the first communication device 12.

Services over wireless communication networks may use capabilities of, for example, the Internet Protocol (IP) multimedia core network subsystem (IMS). The IMS enables IP connections for a communication device and other parties to the communication, such as other communication devices or entities associated with the network. The third generation partnership project (3GPP) has defined use of the GPRS and other technologies (e.g., WLAN) for offering IP connectivity to IMS services. The 3GPP has further defined a call control protocol for use in the IMS based on a session initiation protocol (SIP) and an associated session description protocol (SDP). Similarly, the third generation partnership project 2 (3GPP2) has defined the use of CDMA and other technologies for offering IMS services based on SIP and SDP.

In an embodiment, the communication network 10 is a SIP controlled network. Further, in an embodiment, the communication network 10 is provided at least in part by the IMS. In the IMS, SIP based connection control is handled by SIP proxies called Call Session Control Functions (CSCFs, not shown in the figure). Another appropriate SIP controlled communication system may be used as well.

In a 3G network using GPRS access, a packet data session may be established to carry traffic flows over the network. Such a packet data session is often referred to as a packet data protocol (PDP) context. A PDP context may include a radio bearer provided between a communication device and a radio network controller, a radio access bearer provided between the communication device, the radio network controller and a serving GPRS support node (SGSN), and switched packet data channels provided between the SGSN and a gateway GPRS support node (GGSN). Each PDP context usually provides a communication pathway between a particular communication device and the GGSN and, once established, can typically carry multiple flows. Each flow normally represents, for example, a particular service and/or a media component of a particular service. The PDP context therefore often represents a logical communication pathway for one or more flow across the network. To implement the PDP context between the communication device and the SGSN, radio access bearers (RAB) need to be established which commonly allow for data transfer for the communication device. The implementation of these logical and physical channels is known to those skilled in the art and is therefore not discussed further herein.

The communication device 12 used by an end-user for accessing the communication network 10 may be any appropriate communication device, also called terminal. Examples may comprise user equipment (UE), a mobile station (MS), a cellular phone, a personal digital assistant (PDA) and a personal computer (PC). Further examples may comprise any other equipment operable according to SIP and preferably another suitable network or transport protocol, such as the WSP, the HTTP or the TCP.

A typical communication device may be provided with an antenna or other such transceiver and receiver means for wirelessly receiving and transmitting signals from and to a transceiver network element of a wireless communication system. A communication device may also be provided with a display and a speaker. The operation of a communication device may be controlled by means of a suitable user interface comprising control means, such as a keypad, voice commands, touch sensitive screen or pad, or combinations thereof, or the like. A communication device is typically provided with a processor and memory means as well as software and applications operating the device and enabling operation with other entities. Software, which is able to request services from other entities in a communication system, may be called a client.

The session initiation protocol (SIP) is an application layer control protocol defined in document RFC 3261 “SIP: Session Initiation Protocol”, June 2002, by the Internet Engineering Task Force (IETF) for creating, modifying and terminating sessions with one or more participants. A user connected to a SIP base communication system may communicate with various entities of the communication system based on standardized SIP messages. Communication devices or user who run certain applications on the communication devices are registered with the SIP backbone so that an invitation to a particular session can be correctly delivered to these end points. SIP provides a registration mechanism for devices and users and it applies mechanisms such as location servers and registrars to route the session invitations appropriately.

The details of a session, such as the type of media, codec or sampling rate, are typically not described in SIP headers. Rather, a body of a SIP message may contain a description of a session, encoded in an appropriate protocol format. An example of such protocol format comprises session description protocol (SDP) defined in document RFC 2327 “SDP: Session Description Protocol”, April 1998.

In an embodiment of the invention, the mechanisms described in the above-mentioned patent application “Establishing a push session in a communication system”, may be used. Said patent application describes using SIP to establish a push session, such as a device management (DM) session, and that SIP messages carrying session initiation information, such as SIP INVITE, might be used for MMS notification or the like. This SIP-based push OTA mechanism may be referred to as OTA-SIP, analogically with the push OTA protocols OTA-WSP and OTA-HTTP. Session initiations using SIP may carry to a communication device 12 contents of the PAP received from the PI 24 to the PPG 22. As shown in FIG. 1, the contents of the PAP may originate from the application server 26. The contents of the PAP may originate from other sources as well. The content of the PAP may comprise XML encoded push messages that can be transferred using the HTTP, WSP or TCP connection or another appropriate method. The push session may be treated as a media component, comparable to audio, video or session based messaging. For example, a DM session over a TCP connection, a DM session over the HTTP or a DM session over the WSP may be established. Respectively, MMS notification over TCP connection, HTTP or WSP may be performed. Said information for establishing the push session may be carried in a message body, such as a SDP body of a SIP message.

In a further embodiment of the invention, OTA-HTTP and OTA-WSP push mechanisms as defined in WAP-250-PushArchOverview-20010703-a, or other such push mechanisms, may be used to carry to the communication device 12 contents of the PAP received from the PI 24 to the PPG 22.

A communication device, such as the communication device 12, may support one or more push methods, such as push over HTTP (OTA-HTTP), push over WSP (OTA-WSP) and/or push over SIP (OTA-SIP). The push gateway, such as the PPG 22, should be able to select which push mechanism to use in transmitting push information to a communication device or to a group of communication devices. Communication devices may have different capabilities and may support different push operations. A communication device may be unable to support several simultaneous PDP contexts to different access points. As an example, the communication device may support three different push protocols, such as OTA-SIP, OTA-HTTP and OTA-WSP. If, at a particular moment, a user is using SIP based communications, a communication device may be able to use, at that particular moment, only OTA-SIP, but not the other two supported push protocols OTA-HTTP and OTA-WSP, as using the other protocols would require setting up a different PDP context.

Furthermore, a user of a communication device may prefer a particular push operation to another push operation, even if the communication device supported a number of push operations. Furthermore, user preferences may vary from time to time.

It has now been found that the push entity, such as the PPG 22, might discover or be made aware of push mechanisms that are supported and/or preferred by users of communication devices the push entity is serving by means of a new signaling element, such as a media feature tag, which may be published by a user of the communication device together with presence information of the user.

Presence functionality provides a network-based service for storing and distributing presence information of a user using a communication device to other users using other communication devices. Users may be allowed to subscribe to each other's presence information and be notified of changes in the state. Presence is defined in document RFC 2778 “A Model for Presence and Instant Messaging”, February 2000, by the IETF. It shall be appreciated, however, that the term presence is generally used in a broader scope, indicating not only the availability of a user, but also user preferences and terminal capabilities. For instance, the IETF has developed extensions to the presence documents to indicate devices capabilities, see e.g. the internet draft by the IETF, User Agent Capability Extension to Presence Information Data Format (PIDF), Oct. 24, 2004, draft-ietf-simple-prescaps-ext-02.

Referring back to FIG. 1, presence functionality may comprise a user of the first communication device 12, to send a publication request to the presence server 28 requesting to publish presence information of the user. The publication request may contain presence information of the user encoded in an appropriate format, such as in extensible markup language (XML) format. The presence information may comprise personal information, service information, user preferences and terminal capabilities information. The publication request may be submitted using appropriate signaling, such as in SIP PUBLISH. Further examples of mechanisms for delivering presence information to the presence server may comprise, but are not limited to, HTTP, simple object access protocol (SOAP), or the like. A second entity may be a watcher of the presence information of the user, by subscribing or fetching the presence information from the presence server 28. In embodiments of invention, the second entity may be the PPG 22. For retrieving the presence information, the second entity may send a SIP SUBSCRIBE request message to the presence server 28. The second entity may receive the presence information, if the presence server authorizes the operation, according to some local policy and user indicated policy. The presence information may be delivered to the second entity using appropriate signaling, such as in SIP NOTIFY request.

The presence server 28 may be implemented in an appropriate network element operable in accordance with SIP, such as an application server (AS).

Document RFC 3840 “Indication User Agent Capabilities in the Session Initiation Protocol (SIP)”, August 2004, by the IETF, defines mechanisms by which a first SIP user agent can convey capabilities and characteristics of the first SIP user agent to other user agents and to registrar for a domain of the first SIP user agent. According to RFC 3840, said capabilities and characteristics information is conveyed as parameters of a SIP contact header field, such as in a contact header field of a SIP INVITE request or of a SIP REGISTER request.

When a user publishes presence information associated with the user, typically the user also publishes presence capabilities associated with the user or user's communication device. Internet-Draft by the IETF, “User Agent Capability Extension to Presence Information Data Format (PIDF)”, draft-ietf-simple-prescaps-ext-02, October 2004, defines how the features presented in RFC 3840 can be provided as a part of presence data.

In embodiments of the invention, existing SIP structures are developed further. A new media feature tag indicating terminal capabilities is defined in accordance with the basics of RFC 3840. The term media feature is defined herein, in accordance with RFC 3840, as information that indicates facilities for handling SIP messages. A media feature tag is a name that indicates a media feature. A media feature set brings together information on the media features an entity may support.

According to embodiments of the invention, terminal capabilities information comprises a push media feature tag indicating general push capability. Furthermore, the push media feature tag may comprise at least one subset expressing details of the general push capability. Said details may comprise at least one subset of a push method or push methods, such as push protocols or push events, which are supported by the communication device. Said details may further indicate a user preference for the at least one subset. Examples of said details may comprise, but are not limited to, for example push method, content and duration. Examples of push methods to be indicated in the at least one subset may comprise, but are not limited to, push over SIP, push over HTTP, push over WSP, push over SMS, and so on. Further details may be comprised, such as support for DM, synchronization markup language (SyncML), MMS notification, and so on.

In embodiments of the invention, the push media feature tag together with at least one subset may be published by the presence server 28 together with the presence capabilities associated with the user. When a push gateway, such as the PPG 22, starts a push operation towards a communication device 12 initiated by a push server, such as the PI 24, the push gateway may first fetch presence information for the communication device 12 from the presence server 28, unless such information is already available, for example from a previous operation, at the push gateway PPG 22. When the PPG 22 receives the presence information, the PPG 22 may decide, based on the presence information, how to continue with the push operation.

In an embodiment, the push capabilities supported simultaneously by the communication device and/or preferred by the user are published in the at least one subset of the push media feature tag.

In an embodiment, all the push capabilities supported by the communication device are published in the at least one subset push media feature tag. Optionally, the at least one subset of the push media feature tag may comprise information on user preferences and information which different capabilities may be simultaneously supported by the communication device.

In an embodiment, the communication device may be able to support only one push protocol at the time. The push media feature tag may thus comprise information of the push protocol currently supported.

Embodiments of the invention define the push media feature tag, which is a new media feature tag that indicates the push information. In the following, a non-limiting example is given for excerpt of a possible XML encoding of the push media feature tag and subset when it is embedded into the presence capabilities XML document as defined in the document draft-ietf-simple-prescaps-ext-02. In the following example, the entity supports the device management and MMS notification applications with push. In the following example, the device management is supported with OTA-SIP, OTA-HTTP and OTA-WSP protocols, in that order of preference. The MMS notification is supported with OTA-SIP protocol. The user is interested in a few MMS notifications only.

```
<os:push>
  <os:applications>
    <os:application id=“device-management”>
      <os:protocols>
          <os:protocol preference=“1”>ota-sip</os:protocol>
          <os:protocol preference=“2”>ota-http</os:protocol>
          <os:protocol preference=“3”>ota-wsap</os:protcool>
      </os:protocols>
    </os:application>
    <os:application id=“mms-notification”>
      <os:protocols>
          <os:protocol preference=“1”>ota-sip</os:protocol>
      </os:protocols>
      <os:events>
          <os:event>new-unread-mms</os:event>
          <os:event>delivery-of-sent-mms</os:event>
      <os:events>
    </os:application>
</os:push>
```

It shall be appreciated that the above example can be enhanced with much more complete and complex information. The above example is given only for illustrating an idea of the invention and is only a non-limiting example of a possible implementation.

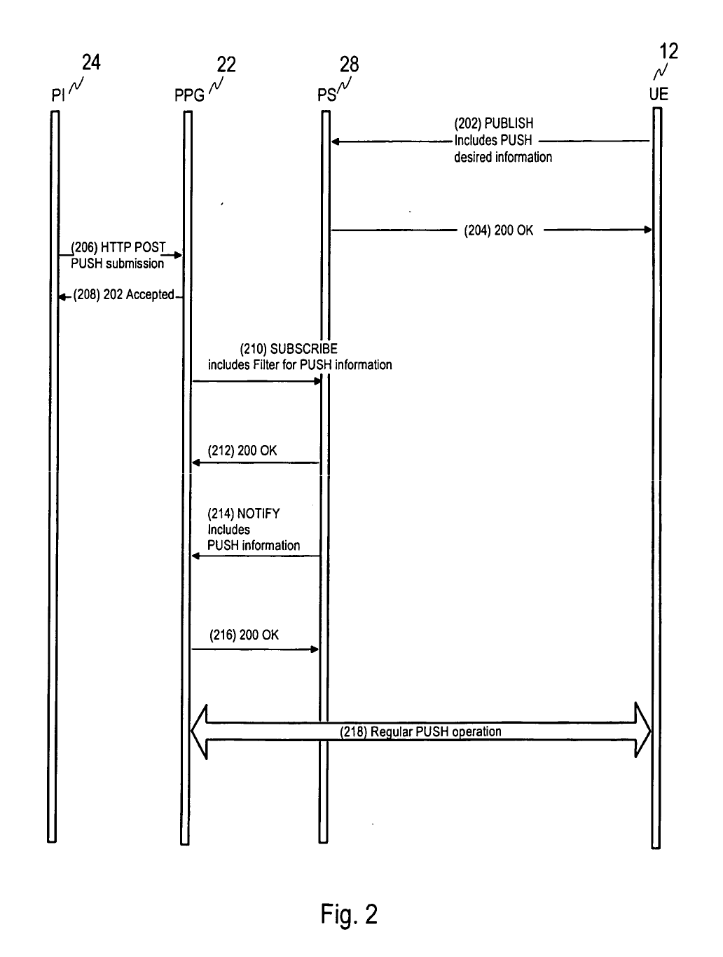

FIG. 2 shows a signaling chart illustrating an embodiment of the invention. A user of a communication device 12 includes in signal 202, such as SIP PUBLISH, user's presence information and presence capabilities including a push media feature tag comprising at least one subset expressing details of push capability. A presence server 28 associated with the communication device 12 receives the signal 202. The presence server 28 stores the information comprised in the push media feature tag and the related information including the at least one subset. The presence server 28 accepts reception of the information in signal 204, such as 200 OK.

In signal 206, a push server, such as the PI 24, sends to a push gateway, such as the PPG 22, a submission to start a push operation towards a communication device, such as the UE 12. This submission may be, for example HTTP POST. The PPG 22 accepts the submission in signal 208.

The PPG 22 starts a fetch operation with the presence server (PS) 28 associated with the UE 12. The fetch operation may be mapped to a fetch request, such as a SIP SUBSCRIBE request, in signal 210. The “Expires” headers of the SIP SUBSCRIBE request may be set to 0. The fetch request preferably also contains a filter to indicate the presence server 28 that the PPG 22 is only interested in receiving information related to the push media feature capabilities. The presence server 28 accepts the fetch request in signal 212.

It shall be appreciated that signals 210 and 212 subscribing to presence information of the user may be performed also in any moment earlier in the signaling chart of FIG. 2. For example, the PPG 22 may subscribe to the presence information before receiving the submission to start the push operation or even before the communication device has published the presence information.

In response to receiving the fetch request the presence server 28 generates a notification, such as a SIP NOTIFY request, that contains the terminal push capabilities of the user, including the terminal push capabilities related to at least one of the devices the user is currently using, such as the UE 12. The SIP NOTIFY request also includes information of the subsets, such as user preferences, for each of the subsets that were included by the user in signal 202. The presence server 28 sends the notification in signal 214 to the PPG 22, which accepts reception in signal 216. The UE 12 may update user's push media feature tag information any time by sending a new PUBLISH request to the presence server 28 (not shown in the figure). The updated push information will replace or add user's push information already stored in presence information of the user in the presence server 28. If the PPG 22 has already subscribed to presence information of the user and the information changes, the presence server 28 may send to the PPG 22 a new NOTIFY request comprising updated push media feature tag information of the user.

Based on information included in the notification, such as the terminal push capabilities, user preferences and other subset information, such as events the user is interested on receiving via different push methods, the PPG 22 decides how to continue with the push operation submitted in signal 206. The PPG 22 may decide to continue the push operation via OTA-SIP, OTA-HTTP or OTA-WSP, or any other push technology or to stop the push operation. In step 218, the PPG 22 proceeds with push operations using the regular push method selected according to above described mechanism.

Document RFC 3841 “Caller Preferences for the Session Initiation Protocol (SIP)”, August 2004, by the IETF, relates to allowing a caller to express preferences about request handling in server. RFC 3841 defines Request-Disposition request header field providing request handling preferences and Accept-Contact and Reject-Contact request header fields providing feature preferences. The caller may select, using the feature preferences, which of the capabilities supported by a called communication device are preferred by the caller.

Caller preference indication according to RFC 3841 may be used in connection with embodiments of the invention. For example, the PI 24 may include in the push submission (signal 206) a caller preference indication. In an embodiment, if a communication device, such as the UE 12, has indicated support for several alternative PUSH methods, a push gateway, such as the PPG 22, can select one of the supported methods based on caller preferences indicated by a push server, such as the PI 24.

A communication device may update terminal PUSH capabilities in the presence server automatically (without user interaction) as a user, or an end user, is normally not aware of all technical capabilities of the communication device. However, the user may choose, for example, what events and which type of information (MMS, DM, and so on) the user wishes to receive via each of supported methods. A non-limiting example may comprise the user setting that MMS notifications are to be received preferably using OTA-WSP and DM information is received preferably using OTA-HTTP.

Furthermore, it shall be appreciated that FIG. 2 shows only one possible method for a user to publish presence information. The exemplifying PUBLISH method (signal 202) of FIG. 2 is originated at a UE. Another possibility may be a so-called network provided presence, where a network entity, such as a S-CSCF, publishes presence information of a user. Network provided presence information might not be able to carry terminal capabilities, because the user may change terminal. However, the network provided presence information could carry some user preferences, which are stored in the network.

Although the invention has been described in the context of particular embodiments, various modifications are possible without departing from the scope and spirit of the invention as defined by the appended claims. It should be appreciated that whilst embodiments of the present invention have mainly been described in relation to mobile communication devices such as mobile stations, embodiments of the present invention may be applicable to other types of communication devices that may access communication networks. Furthermore, embodiments may be applicable to other appropriate communication systems, even if reference has mainly been made to mobile communication systems. It is appreciated that the invention is not limited to any particular access technology, but any access technology usable in connection with push methods may be used in embodiments of the invention.

1. A method for controlling push operations in a communication system, the method comprising:
requesting capabilities information associated with a communication device, the capabilities information comprising an indication of at least one first push method supported by the communication device;
receiving said capabilities information; and
deciding a way to handle a push operation towards the communication device based on said capabilities information.

2. The method according to claim 1, wherein the step of receiving said capabilities information further comprises receiving an indication of at least one second push method a user of the communication device prefers to be used in push operations, wherein the at least one second push method is included in said at least one first push method supported by the communication device.

3. The method according to claim 1, wherein the step of receiving said capabilities information further comprises receiving information on at least one service and a preferred push method to be used for the at least one service.

4. The method according to claim 1, wherein the step of receiving said capabilities information comprises receiving the indication of support for at least one of push over a session initiation protocol, push over a hypertext transfer protocol, push over a wireless session protocol and push over short message service.

5. The method according to claim 1, wherein the step of deciding comprises deciding to use one of the at least one first push method indicated in said capabilities information for handling the push operation.

6. The method according to claim 1, wherein the step of deciding comprises comparing at least one third push method supported by an entity handling the push operation and deciding to use one of the at least one first push method indicated in said capabilities information for handling the push operation when the one of the at least one first push method is found to be included in the at least one third push method supported by the entity.

7. The method according to claim 6, wherein the step of deciding further comprises comparing at least one fourth push method preferred by the entity handling the push operation and deciding to use one of the at least one second push method indicated in said capabilities information for handling the push operation when the one of the at least one second push method is found to be included in the at least one fourth push method preferred by the entity.

8. The method according to claim 1, further comprising receiving a submission to start the push operation towards the communication device.

9. The method according to claim 8, wherein the step of receiving the submission comprises receiving the submission indicating a preferred push method to be used.

10. The method according to claim 9, wherein the step of deciding comprises comparing said capabilities information to the preferred push method indicated in the submission and deciding to use said preferred push method if included in said capabilities information.

11. The method according to claim 9, wherein the step of deciding further comprises deciding to use another push method indicated in said capabilities information than the preferred push method indicated in the submission if said preferred push method is not included in said capabilities information.

12. The method according to claim 9, wherein the step of deciding further comprises deciding to stop the push operation if said preferred push method is not included in said capabilities information.

13. A computer program embodied on a computer-readable medium, the computer program configured to control a computing means to perform the steps of:
requesting capabilities information associated with a communication device, the capabilities information including an indication of at least one first push method supported by the communication device;
receiving the capabilities information; and
deciding a way to handle a push operation towards the communication device based on said capabilities information.

14. A method for transmitting information in a communication system, the method comprising:
receiving capabilities information associated with a communication device, the capabilities information comprising an indication of at least one first push method supported by the communication device;
storing said capabilities information as a part of presence information;
receiving a request for said capabilities information;
selecting said capabilities information from the presence information in response to the request; and
providing said capabilities information.

15. The method according to claim 14, further comprising evaluating authorization rules relating to an entity requesting the capabilities information and providing said capabilities information when the authorization rules authorize said providing.

16. A signaling element for carrying information in a communication system, the signaling element configured to provide information on the at least one push method supported by a communication device.

17. The signaling element according to claim 16, configured to provide information on at least one second push method a user of the communication device prefers to be used in push operations.

18. The signaling element according to claim 16, configured to provide additional information on at least one service and a preferred push method to be used for the at least one service.

19. The signaling element according to claim 16, configured to provide an indication of support for at least one of push over a session initiation protocol, push over a hypertext transfer protocol, push over a wireless session protocol and push over short message service.

20. The signaling element according to claim 16, configured to be transmitted from a communication device to a push gateway via a network entity controlling presence information.

21. A method for publishing capabilities information in a communication system, the method comprising:
creating a request for publishing capabilities information associated with a communication device, the capabilities information comprising an indication of at least one push method supported by the communication device; and
transmitting the request to a network entity controlling presence information.

22. The method according to claim 21, wherein the step of creating comprises creating said request based on at least one of device capabilities, user preferences and an input of a user of the device.

23. A push gateway for a communication system, the push gateway configured to:
request capabilities information associated with a communication device, the capabilities information comprising an indication of at least one push method supported by the communication device;
receive said capabilities information; and
decide a way to handle a push operation towards the communication device based on said capabilities information.

24. A push gateway for a communication system, the push gateway comprising:
requesting means for requesting capabilities information associated with a communication device, the capabilities information comprising an indication of at least one push method supported by the communication device;
receiving means for receiving said capabilities information; and
deciding means for deciding a way to handle a push operation towards the communication device based on said capabilities information.

25. A communication device configured to:
create a request for publishing capabilities information associated with the communication device, the capabilities information comprising an indication of at least one push method supported by the communication device; and
transmit the request to a network entity controlling presence information.

26. A communication device comprising:
creating means for creating a request for publishing capabilities information associated with the communication device, the capabilities information comprising an indication of at least one push method supported by the communication device; and
transmitting means for transmitting the request to a network entity controlling presence information.

27. A communication system configured to:
provide a submission to start a push operation towards a communication device;
obtain capabilities information associated with the communication device, the capabilities information comprising an indication of at least one push method supported by the communication device; and
decide a way to handle the push operation based on said capabilities information.

28. A communication system comprising:
at least one push initiator for submitting push operations towards at least one communication device; and
a push gateway for performing the push operation towards the at least one communication device; and
a presence server for storing and providing capabilities information associated with a communication device, the capabilities information comprising an indication of at least one push method supported by the communication device;
wherein the push gateway is configured to fetch said capabilities information from the presence server and to decide a way to handle the push operation based on said capabilities information.
